(19) United States
(12) Patent Application Publication
(10) Pub. No.: US 2004/0047146 A1
(43) Pub. Date: Mar. 11, 2004

(54) Safety apparel and signage with LED display

(76) Inventors: David Galoob, Moss Beach, CA (US); Hing Wing Fung, Hong Kong (CN)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 10/142,139

(22) Filed: May 9, 2002

(51) Int. Cl. F21V 21/08

(52) U.S. Cl. 362/103; 362/812

(57) ABSTRACT

An article of clothing with an LED display is provided. The article of clothing includes a plurality of LEDs forming nomenclature that provides identifying information, such as a word or symbol. A strobing unit is connected to the display, such as through a flexible circuit board. The strobing unit provides one or more power signals that cause the LED display to generate strobed light, so that emergency workers can be readily identified by an observer even in darkness, rain, smoke, fog, or other conditions where visibility is limited.

### FIELD OF THE INVENTION

The present invention is related to apparel having light emitting diode (LED) displays, and is more specifically related to apparel and signage for emergency and safety workers that includes strobing LED displays, nomenclature, and other features that enhance the ability of emergency workers to be located.

### BACKGROUND OF THE INVENTION

Articles of clothing with embedded light sources are known in the art. These articles of clothing generally include aesthetic displays or designs that are formed from the embedded light sources. A light generation unit, such as light emitting diodes (LEDs), generates light that causes the display to be visible. In some displays, the lights change color, or are sequenced so as to create an appearance of motion in the display.

Although such clothing with embedded light sources is known, it has typically been used only for aesthetic purposes. Having light emitting designs on clothing inherently increases the visibility of the clothing, but no additional features have been provided other than aesthetic features by such existing embedded light source clothing designs. For example, while light-emitting designs have been provided that identify the wearer, no additional features have been provided that do more observers. Thus, if an observer were looking for a specific person, prior art systems would not assist the observer in making such a determination.

### SUMMARY OF THE INVENTION

In accordance with the present invention, emergency apparel with an embedded LED display is provided that overcomes known problems with emergency apparel.

In particular, emergency apparel with an embedded LED display is provided that utilizes strobing in a manner that makes it easier for observers to locate emergency workers based on the function performed by the emergency worker.

In accordance with an exemplary embodiment of the present invention, an article of clothing with embedded LEDs is provided, such as one that includes a display formed by LEDs on a flexible circuit board.

An article of clothing with an LED display is provided. The article of clothing includes a plurality of LEDs forming nomenclature that provides identifying information, such as a word or symbol. A strobing unit is connected to the display, such as through a flexible circuit board. The strobing unit provides one or more power signals that cause the LED display to generate strobed light, so that emergency workers can be readily identified by an observer even in darkness, rain, smoke, fog, or other conditions where visibility is limited.

The present invention provides many important technical advantages. One important technical advantage of the present invention is an article of clothing with an embedded LED nomenclature display that emits strobed light. Unlike constant lighting or animated displays, strobed light is more visible in conditions where visibility is limited, and allows text, nomenclature, or other features to be more readily distinguished so as to facilitate the identification of the function performed by the wearer of the article of clothing.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of an LED display in accordance with an exemplary embodiment of the present invention;

FIG. 2 is a diagram of an article of clothing in accordance with an exemplary embodiment of the present invention;

FIG. 3 is a diagram of an article of clothing that includes an active display and uniform reflective patterns throughout the article of clothing in accordance with an exemplary embodiment of the present invention;

FIG. 4 is a diagram of an article of clothing that includes a multi-dimensional reflective feature in accordance with an exemplary embodiment of the present invention;

FIG. 5 is a diagram of an article of clothing in accordance with an exemplary embodiment of the present invention;

FIG. 6 is a diagram of a system for providing strobing functionality for an article of clothing in accordance with an exemplary embodiment of the present invention;

FIG. 7 is a flow chart of a method for manufacturing an article of clothing with passive and active lighting in accordance with an exemplary embodiment of the present invention; and

FIG. 8 is a flow chart of a method for providing strobe rate controls to a display on an article of clothing in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

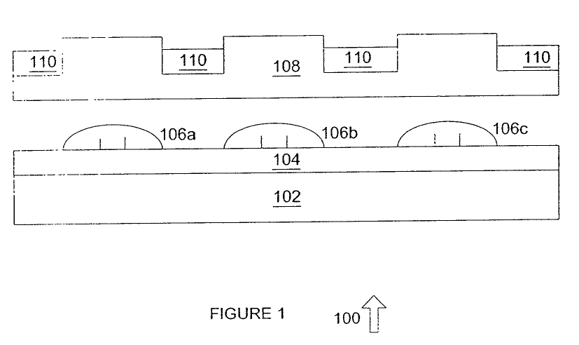

FIG. 1 is a diagram of an LED display 100 in accordance with an exemplary embodiment of the present invention. LED display 100 includes backing vinyl layer 102, which is adhered to or otherwise disposed behind flexible printed circuit board 104. LEDs 106a, 106b, and 106c are coupled to flexible printed circuit board 104 such that power can be applied to each in series, in parallel, in sequence, or in other suitable manners. LEDs 106a, 106b, and 106c can be manufactured using surface-mount technology or other suitable processes, so as to allow the LED structure to be flat enough LEDs 106a, 106b, and 106c so as to form an optical path for viewers to see LEDs 106a, 106b, and 106c when they are illuminated. This optical path can be used with surface-mount technology LEDs to provide lensing and concentration of the light. Opaque vinyl layer 110 is likewise disposed over LEDs 106a, 106b, and 106c and translution vinyl layer 108, so as to block light emitted from LEDs 106a, 106b, and 106c. In this manner, the light from LEDs 106a, 106b, and 106c is focused and concentrated within a user-readable display. LED display 100 can be used to spell out words, create designs or symbols, or otherwise create nomenclature.

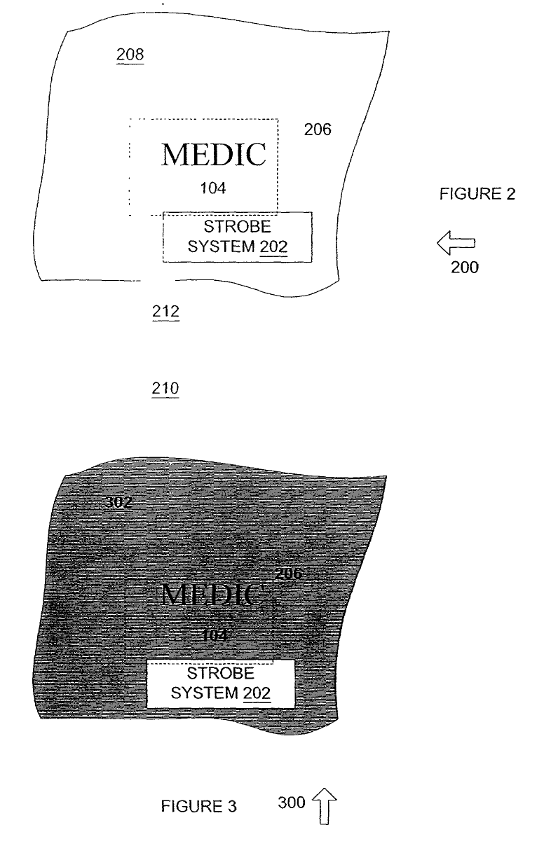

FIG. 2 is a diagram of an article of clothing 200 in accordance with an exemplary embodiment of the present invention. Article of clothing 200 can be a coat, shirt, hat, pants, or other suitable articles of clothing that include an LED design with strobed light that increases the noticeability of the LED design, such as when safety personnel wear the clothing in order to be easily recognized by members of the public or persons requiring their services.

Article of clothing 200 includes strobe system 202 that is coupled via flexible circuit board 204 to display 206. In one exemplary embodiment, strobe system 202 can be implemented in hardware, software, or a suitable combination of hardware and software, and can be one or more hardware systems, one or more software systems operating on a processing platform, or other suitable systems. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of software in a specific purpose software application.

Strobe system 202 is coupled to display 206 through flexible circuit board 204. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. In one exemplary embodiment, systems and components are coupled to other systems and components through intervening systems and components, such as through an operating system of a digital signal processor.

Strobe system 202 allows display 206 to be more readily identified by an observer, such as to allow the observer to make out words, nomenclature, or to otherwise locate the wearer when the observer is looking for the wearer under conditions that make viewing difficult, such as darkness, smoke, fog, rain, or a combination of such conditions. In one exemplary embodiment, display 206 can be formed from LEDs on a flexible circuit board that is encased in a weatherproof material, and is connected to strobe system 202.

Material 208 can be a natural, synthetic, or hybrid fabric or other material on which display 206 is provided. Strobe system 202 can be physically attached to material 208, can be placed in a pocket of material 208, can be worn on a belt such that strobe system 202 is coupled to flexible circuit board 204, or other suitable configurations for material 208 can be provided.

In operation, article of clothing 200 is used to provide display 206 on material 208 for use by suitable personnel. In one exemplary embodiment, emergency personnel such as medical personnel, firemen, police, or other suitable personnel can wear article of clothing 200 with display 206 that is illuminated by strobe system 202. Strobe system 202 can cause display 206 to blink at a rate that makes display 206 noticeable. In this exemplary embodiment, the rate can be adjusted so as to be noticeable when standing still, to appear to be constant when standing still but to appear to flash when moving so as to provide increased noticeability when the wearer of article of clothing 200 is moving, to conserve battery power, to allow the user to control the strobe rate, or in other suitable embodiments. Likewise, the rate of strobing can be adjusted to make different teams of personnel identifiable to team captains, to make persons having different functions easier to differentiate to observers, or for other suitable purposes that result in easier identification of the wearer's identity or function.

Article of clothing 200 and other suitable articles of clothing described herein can also be a patch that is attached to another article of clothing, such as with velcro, snaps, or other suitable connectors so as to allow the LED display, nomenclature, words, symbols, or other features that are illuminated to be changed, to allow a discharged strobe system 202 to be replaced with one that is fully powered, or for other suitable purposes. In one exemplary embodiment, display 206 can also be attached to a handle and used as a sign, such as by using velcro, snaps or other suitable connectors. Display 206 can also be used in conjunction with a first nomenclature, such as the word “STOP,” and a second side of the sign includes a second nomenclature, such as the word “SLOW.” Other suitable sets of nomenclature can likewise be used. The power source for display 206 can be provided in a handle 210 of the sign, and a switch 212 can be provided that allows one of the nomenclature to be illuminated while the other is not illuminated, that allows both nomenclature to be illuminated, or that otherwise allows illumination of the nomenclature to be selectable. In one exemplary embodiment, the switch can be positioned in the handle such that the user can depress a trigger or other suitable device that allows the nomenclature on a side of the sign facing in a predetermined direction to be illuminated.

FIG. 3 is a diagram of an article of clothing 300 that includes an active display and uniform reflective patterns in accordance with an exemplary embodiment of the present invention. Article of clothing 300 includes strobe system 202 that is coupled to display 206 through flexible circuit board 204. In addition, article of clothing 300 has a reflective pattern 302 placed on it that is formed from a reflective material, such as with a rotary screen, a roller screen, flat-bed screen printing techniques, or other suitable techniques. In this manner, reflective pattern 302 is painted, heat bonded, or otherwise incorporated onto the cloth. In one exemplary embodiment, a reflective microspherical pattern printing material or other suitable chemical compound formed from chemical binders that can contain 80% aluminum and 20% glass microspheres in a heat treatable slurry can be used to create the repeated pattern. The reflective material can reflect in 160 degrees of arc or more in one exemplary embodiment. The repeated pattern can be provided on a portion of article of clothing 300, on the entire surface of article of clothing 300, or in other suitable configurations. In one exemplary embodiment, the pattern can be words, stripes, safety designs, commercially recognized safety symbols, or other suitable designs.

In operation, article of clothing 300 provides active and passive features for increasing the visibility of the wearer. In conjunction with strobe system 202 and display 206, the reflective pattern on article of clothing 300 allows the wearer to be readily distinguished at a distance, and further allows the function performed by the wearer to be readily identified by an observer. For example, in prior art systems in which reflective materials were applied to clothing, the primary purpose of the reflectivity was to increase the noticeability of the wearer. Nevertheless, although noticeability can be increased through the use of reflective materials, the wearer will not be visible if there is no light being shown on the wearer. Likewise, reflective materials that are used to identify the wearer are generally used to help the wearer avoid from being struck by a vehicle or to otherwise provide an indication of where the wearer is. Article of clothing 300 includes features that allow the function performed by the wearer to be identified, such as to allow the wearer to be identified in the dark by an observer without a flashlight or other lighting device, and to allow the wearer to be more readily located when such a light device is shined on the wearer.

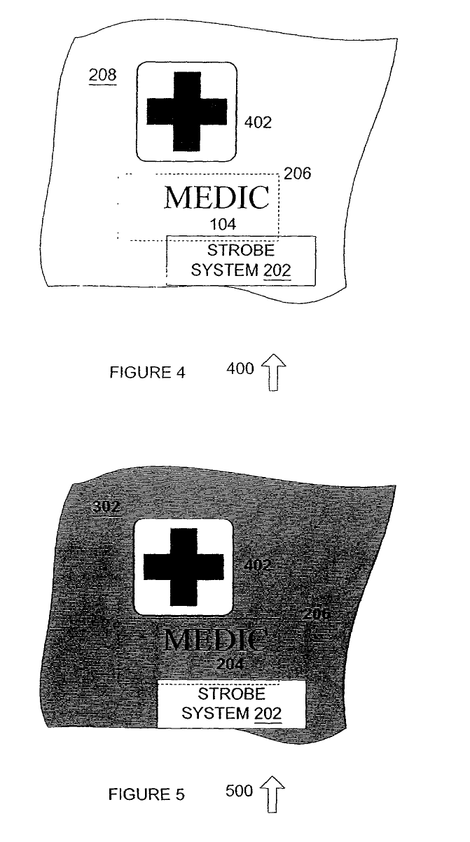

FIG. 4 is a diagram of an article of clothing 400 that includes a multi-dimensional reflective feature in accordance with an exemplary embodiment of the present invention.

Article of clothing 400 includes strobe system 202 and display 206, and further includes multi-dimensional reflective feature 402. Multi-dimensional reflective feature 402 can be formed from polyvinyl chloride (PVC) or other suitable materials that can include a reflective material that has angular surfaces disposed about multi-dimensional reflective feature 402. Thus, the reflective surfaces of multi-dimensional reflective feature 402 can reflect based on the angle of the viewer to the plane of multi-dimensional reflective feature 402. In this manner, a viewer can identify both the location and function of the wearer of article of clothing 400 by either multi-dimensional reflective feature 402, display 206, or both multi-dimensional reflective feature 402 and display 206. Likewise, if the battery for display 206 wears out, then multi-dimensional reflective feature 402 can also be used to provide passive identification of the wearer of article of clothing 300. Likewise, multi-dimensional reflective feature 402 can be used in conjunction with display 206, such as to spell the same words spelled by display 206 so as to provide active and passive identification of the wearer of article of clothing 300.

FIG. 5 is a diagram of an article of clothing 500 in accordance with an exemplary embodiment of the present invention. Article of clothing 500 includes both active display 206, reflective pattern 302, and multi-dimensional reflective feature 402, so as to increase the noticeability of the wearer of article of clothing 500 and to allow observers to determine a function performed by the wearer. Providing reflective pattern 302 on article of clothing 400 with multi-dimensional reflective feature 402 increases the passive identification capability for observers of wearers of article of clothing 500. Likewise, by providing display 206 with article of clothing 500, the wearer of article of clothing 500 can be readily identified by a person and can be easily located in situations where visibility is poor, such as in the rain, in the dark, in a smoky environment, in fog, or in other similar environment

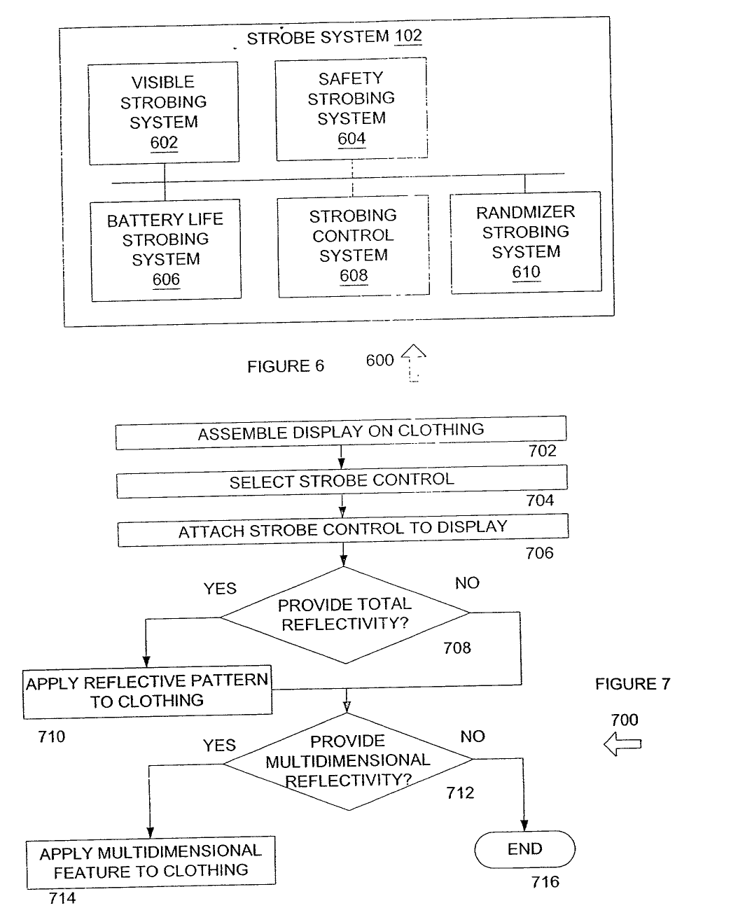

FIG. 6 is a diagram of a system 600 for providing strobing functionality for an article of clothing in accordance with an exemplary embodiment of the present invention. System 600 includes strobe system 202 and visible strobing system 602, safety strobing system 604, battery life strobing system 606, strobing control system 608, and randomizer strobing system 610, each of which can be implemented in hardware, software, or a suitable combination of hardware and software, and which can be one or more hardware systems, or one or more software systems operating on a suitable processor platform.

Visible strobing system 602 generates strobe rate data that causes a strobe light to strobe at a rate that creates a visible strobing effect. In one exemplary embodiment, visible strobing system 602 can provide strobe rate data that allows strobing to occur at a rate that has been determined to be optimally visible for a wearer that is standing still, such as less than 20 flashes per second. In this manner, visible strobing system 602 can be provided alone or as a selectable strobing system to provide strobing functionality.

Safety strobing system 604 provides strobe rate data to strobe a light at a rate that appears to be constant to an observer if the wearer of the strobe system is standing still, but which creates an optical effect that is more noticeable than a constant light to the observer if the wearer of the article of clothing is moving. Depending on the rate of motion, strobing may be intermittently or continuously apparent during movement. In one exemplary embodiment, safety strobing system 604 can strobe the light at a rate faster than 30 flashes per second, which can be a length of time or a number of flashes per second perceivable by the human eye to be constant, or slower than 30 flashes per second. Safety strobing system 604 can also increase the amount of time between each flash such as to increase the noticeability of the strobing light when the wearer is moving. Thus, for a stationary “frame,” 30 flashes per second might appear to an observer to be a constant light. However, for a moving frame, the number of “frames” presented to the observer will be less than 30 per second. In this manner, safety strobing system 604 creates an effect that increases the noticeability of a display that is being strobed. If the display is used to spell the safety function of a wearer such as medical personnel, policemen, parking attendants, hazardous chemical clean up crews, firemen, paramedics, or other suitable safety personnel, or to illuminate symbols or other features that identify a safety function, the noticeability can be increased so as to allow observers that require services from such safety personnel to readily locate them even in a low light environment such as in the dark, in the rain, in a smoky environment, or in other suitable low light environments.

Battery life strobing system 606 generates strobe rate data that maximizes battery life. In one exemplary embodiment, battery life strobing system 606 can include selectors that allow a user to select the strobing rate based on the amount of time or life that the battery must last. In another exemplary embodiment, battery life strobing system 606 can be used in conjunction with visible strobing system 602, safety strobing system 604, and other suitable systems to provide strobing at a rate that performs the functions of these other systems but which maximizes the battery life.

Strobing control system 608 allows a user to select a strobe rate. In one exemplary embodiment, strobing control system 608 can include a user selectable control such as a potentiometer, digital controls, or other suitable controls, enter a strobe rate, or provide strobe rate control data in other suitable manners. Strobing control system 608 can also be used in conjunction with other strobing systems such as visible strobing system 602, safety strobing system 604, and battery life strobing system 606, such as to allow a wearer of strobing control system 608 to select from one or more control selections for one or more of these systems.

Randomizer strobing system 610 generates randomized or non-periodic strobing rates that increase the noticeability of a display that is illuminated by light strobed at the randomized rates. In one exemplary embodiment, the display can be strobed at randomized rates using randomizer strobing system 610 that appear to be constant when the display is stationary, but where the randomized strobing rate is noticeable when the display is moving. Other suitable randomized rates can also or alternatively be used.

In operation, system 600 provides strobing for a display on an article of clothing in a manner that facilitates or enhances safety features of the article of clothing. System 600 can be used to strobe the light used to illuminate a display so that the strobing is visible when the wearer is standing still, so that the strobing rate appears to be constant when the wearer is standing still but creates a noticeable effect that draws attention to the wearer when the wearer is moving, can be used to prolong battery life, and can allow a user to select the strobe rate. In this manner, system 600 enhances the noticeability of a wearer of an optical display so as to allow the function of the wearer to be readily determined by others who may require services from the wearer.

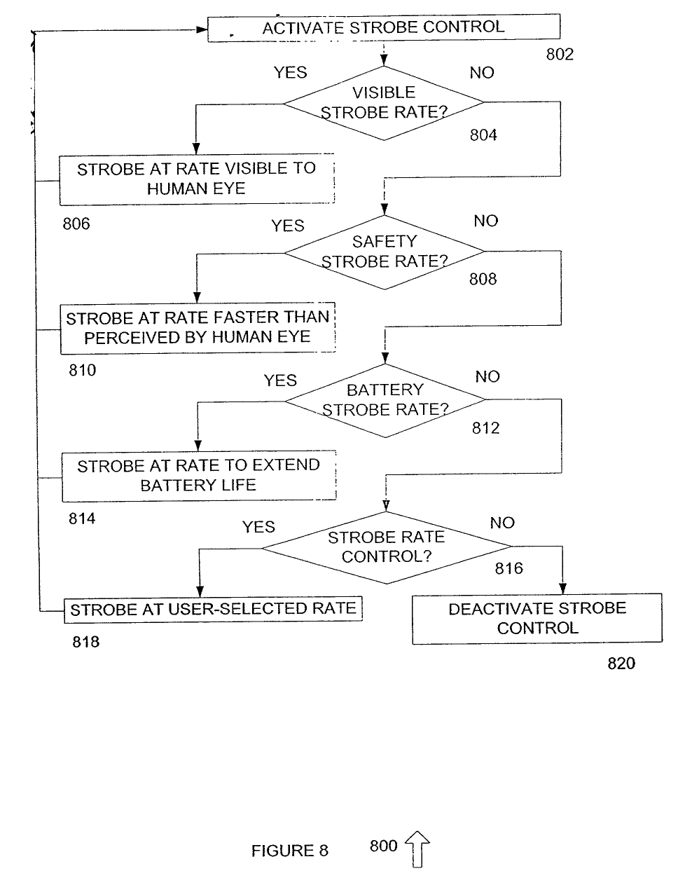

FIG. 7 is a flow chart of a method 700 for lighting in accordance with an exemplary embodiment of the present invention. Method 700 allows articles of clothing to be manufactured that include strobing functions and passive reflective features that enhance, the use of the article of clothing for safety purposes, such as for wearing by safety personnel to allow the safety personnel to be readily identified, as opposed to simply increasing the noticeability of a wearer of the article of clothing.

Method 700 begins at 702 where an LED display on, a flexible circuit board is assembled in the clothing. In one exemplary embodiment, the LED display can be used to spell out an identifying title of the wearer, such as “POLICE,” “MEDIC,” “PARAMEDIC,” “PARKING ATTENDANT,” “HAZARDOUS CHEMICAL HANDLER,” “RADIATION PERSONNEL,” or other suitable personnel. In this exemplary embodiment, sequencing can be used to create the display, such as when two or more words are used to identify the wearer, the first word can be illuminated followed by the second word. Other suitable display configurations can likewise be used. The method then proceeds to 704.

At 704, a strobe control is selected for provision with the article of clothing. In one exemplary embodiment, the strobe control can be selected based upon the function of the wearer, the expected application (such as for use in the dark, in rain, in smoke, or other suitable applications), or based upon other suitable use parameters. The strobe control can likewise be selected by the wearer prior to putting on the article of clothing, at the time of manufacture, such as where the strobe control is to be permanently attached to the article of clothing, or in other suitable manners. The method then proceeds to 706.

At 706, the strobe control is attached to the -LED configured for attachment to the strobe control. The method then proceeds to 708.

At 708 it is determined whether total textile reflectivity for the article of clothing is to be provided. For example, the entire article of clothing can be provided with reflective patterning, reflective patterns can be provided to portions of the article of clothing such as stripes or safety symbols or words, or other suitable reflectivity patterning can be provided. If it is determined at 708 that total reflectivity is not required the method proceeds to 712. Otherwise the method proceeds to 710 where a reflective pattern is applied to the clothing. In one exemplary embodiment, a textile reflective microspherical pattern printing can be used, such as using 80% aluminum and 20% glass microspheres as previously described or other suitable materials. In this exemplary embodiment, both active and passive identification devices are used to increase the viewability or observability of the wearer. Likewise, the reflective pattern can include words and symbols that also identify the safety function of the wearer, such as to allow observers to identify the wearer when the active strobing illumination of the display runs out of batteries.

At 712 it is determined whether multi-dimensional reflectivity is to be provided. In one exemplary embodiment, the multi-dimensional reflectivity can include polyvinyl chloride or other suitable materials that are reflective along planar faces, where an embossed feature such as a symbol or word is provided that has planar faces viewable by observers at different angles. If it is determined at 712 that a multi-dimensional reflective feature is to be provided the method proceeds to 714, where the multi-dimensional feature is applied to the clothing. In one exemplary embodiment, the feature can be heat embossed, can be a detachable patch or other suitable application and procedures can be used. Otherwise, if it is determined at 712 that a multi-dimensional reflective feature is not to be provided the method proceeds to 716 and terminates.

In operation, method 700 allows an article of clothing to be manufactured for safety personnel, to increase the ability of observers to identify the function performed by the safety personnel so that the safety personnel can be contacted for assistance. In this manner, method 700 provides both active and passive identification indicia, such as reflective features, reflective features that are applied to the entire article of clothing, multi-dimensional features that increase the ability of the observer to notice the wearer, active features, or other suitable features. Method 700 thus allows articles of clothing to be manufactured that provide features beyond those that simply increase the visibility of the wearer, and allow additional information about the wearer to be communicated in a manner that increases the ability of the information to be transmitted to the observer.

FIG. 8 is a flow chart of a method 800 for providing strobe rate controls to a display on an article of clothing in accordance with an exemplary embodiment of the present invention. Method 800 allows the strobe rate for a display on an article of clothing to be controlled so as to enhance the ability of observers to identify the function of the wearer and location of the wearer, to prolong battery life, and to provide other suitable functions.

Method 800 begins at 802 where a strobe control is activated. In one exemplary embodiment, the strobe control can be activated when an LED display is inserted into the strobe control, when the switch is turned on, or in other suitable manners. The method then proceeds to 804.

At 804 it is determined whether a visible strobe rate is to be provided. In one exemplary embodiment, the visible strobe rate can include a strobe rate that facilitates the ability of observers to notice the strobing effect when the wearer is standing still. For example, strobing at rates slower than 20 to 30 flashes per second will usually allow the strobe rate to be detected by the observer. Likewise, the length of time between flashes and the amount of dark time between flashes can be adjusted, so as to decrease the amount of dark time, increase the amount of dark time, or in other suitable manners. If it is determined at 804 that a visible strobe rate is not required the method proceeds to 808. Otherwise the method proceeds to 806 where a strobe rate is generated that causes the display to flash at a rate visible to the human eye. The method then returns to 802.

At 808 it is determined whether a safety strobe rate is required. In one exemplary embodiment, the safety strobe rate can be strobing of a light at a rate that appears constant when the wearer is standing still but which will be visible to the observer and noticeable thus drawing attention to the wearer when the wearer is moving. In this exemplary embodiment, strobing at a rate faster than approximately 30 flashes per second may be perceived to be constant to a human observer, but depending on the amount of dark time between flashes and the rate at which the wearer is moving, may increase the visibility of the wearer by creating a visual phenomenon that is unusual and which attracts attention to the wearer. If it is determined at 808 that a safety strobe rate is not required the method proceeds to 812. Otherwise the method proceeds to 810 where a strobe rate is generated that is faster than perceived by the human eye but which has other features to optimize the noticeability when the wearer is moving. The method then returns to 802.

At 812 it is determined whether a battery strobe rate is required to provide battery life of a predetermined period, to maximize battery life for certain modes of operation, or for other suitable battery conserving strobe rates. If it is determined at 812 that a battery strobe rate is not required the method proceeds to 816. Otherwise the method proceeds to 814 where the strobe rate is adjusted to extend the battery life in accordance with preset or user selected parameters. The method then returns to 802.

At 816 it is determined whether a strobe rate control that allows a user to select the strobe rate is being used. If the user is not selecting the strobe rate the method returns to 802, otherwise the method proceeds to 818 where the user selected strobe rate is used to set the rate of strobing. In one exemplary embodiment, the user can select the rate of strobing, the amount of dark time between flashes (such as a percentage of the cycle), or other suitable parameters. The method then returns to 802.

In operation, method 800 allows strobing of a display on an article of clothing in a manner that enhances the observability of the wearer of the article of clothing, allows a function of the wearer to be readily determined, and prolongs battery life. Method 800 thus allows the strobing for a display on an article of clothing to be optimized to enhance and assist with the safety functions of safety personnel.

In one exemplary embodiment, method 800 can be used to enhance the operations of safety personnel by allowing them to be readily identified by an observer according to a function performed by the wearer of an article of clothing. Method 800 thus allows policemen, paramedics, parking attendants, hazardous waste removal personnel, or other personnel to improve their ability to provide services by allowing observers to readily determine the function of the wearer of the article of clothing in any low visibility or visibility impaired environment, such as in the dark, in the rain, in fog, in smoke, in crowds, or in other areas where it is necessary to increase the ability for observers to determine a function performed by a person and the visibility of the person.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. An article of clothing with an LED display comprising:
a plurality of LEDs forming nomenclature that provides identifying information; and
a strobing unit coupled to the display, the strobing unit providing one or more power signals that cause the LED display to generate strobed light.

2. The article of clothing of claim 1 wherein the strobing unit further comprises a visible strobing system generating strobe rate data that causes the strobed light to flash at a rate that is visible to a human eye.

3. The article of clothing of claim 1 wherein the strobing unit further comprises a safety strobing system generating strobe rate data that causes the strobed light to flash at a rate that appears constant to a human eye when the article of clothing is stationary but which is noticeable when the article of clothing is moving.

4. The article of clothing of claim 1 wherein the display further comprises a layer of translution vinyl over the plurality of LEDs.

5. The article of clothing of claim 1 wherein the strobing unit further comprises a battery life strobing system generating strobe rate data that causes the strobed light to flash at a rate that maximizes battery life.

6. The article of clothing of claim 1 wherein the strobing unit further comprises a strobing control system receiving generating user-selectable strobe rate data that causes the strobed light to flash at a rate selected by a user.

7. The article of clothing of claim 1 further comprising a reflective pattern applied to the article of clothing.

8. The article of clothing of claim 1 further comprising a multidimensional reflectivity feature applied to the article of clothing.

9. The article of clothing of claim 1 wherein the display further comprises:
a layer of translution vinyl over the plurality of LEDs; and
a layer of opaque vinyl over the layer of translution vinyl.

10. A method for manufacturing an article of clothing with an LED display comprising:
installing a plurality of LEDs on a flexible circuit board;
selecting a strobe control system providing strobe control signals to the LEDs; and
providing the strobe control system with the article of clothing.

11. The method of claim 10 wherein installing the plurality of LEDs on the flexible circuit board further comprises disposing a layer of translution vinyl over the LEDs.

12. The method of claim 10 wherein installing the plurality of LEDs on the flexible circuit board further comprises:
disposing a layer of translution vinyl over the LEDs; and
disposing a layer of opaque vinyl over the layer of translution vinyl.

13. The method of claim 10 wherein selecting the strobe control system comprises selecting a visible strobing system generating strobe rate data that causes the strobed light to flash at a rate that is visible to a human eye.

14. The method of claim 10 wherein selecting the strobe control system comprises selecting a safety strobing system generating strobe rate data that causes the strobed light to flash at a rate that appears constant to a human eye when the article of clothing is stationary but which is noticeable when the article of clothing is moving.

15. The method of claim 10 wherein selecting the strobe control system comprises selecting a battery life strobing system generating strobe rate data that causes the strobed light to flash at a rate that maximizes battery life.

16. The method of claim 10 further comprising applying a reflective pattern to the article of clothing.

17. The method of claim 10 further comprising applying a multidimensional reflectivity feature applied to the article of clothing.

18. A sign with an LED display comprising:
a plurality of LEDs forming nomenclature that provides identifying information; and
a strobing unit coupled to the display, the strobing unit providing one or more power signals that cause the LED display to generate strobed light.

19. The sign of claim 18 wherein a first side of the sign displays a first nomenclature and a second side of the sign displays a second nomenclature.

20. The sign of claim 18 further comprising:
a switch for turning on one a first nomenclature and a second nomenclature; and
wherein a first side of the sign displays the first nomenclature and a second side of the sign displays the second nomenclature.
